(19) United States
(12) Patent Application Publication
(10) Pub. No.: US 2014/0050173 A1
(43) Pub. Date: Feb. 20, 2014

(54) Method and Apparatus for Multi-User Data Transmission in Wireless Local Area Network

(71) Applicant: Huawei Technologies Co., Ltd., Shenzhen (CN)

(72) Inventors: Lvxi Yang, Shenzhen (CN); Hao Li, Shenzhen (CN); Chunguo Li, Shenzhen (CN); Tianyu Wu, Shenzhen (CN)

(73) Assignee: Huawei Technologies Co., Ltd., Shenzhen (CN)

(21) Appl. No.: 14/064,349

(22) Filed: Oct. 28, 2013

Related U.S. Application Data
(63) Continuation of application No. PCT/CN2012/074641, filed on Apr. 25, 2012.

(30) Foreign Application Priority Data
Apr. 29, 2011 (CN) 201110111350.1
Sep. 20, 2011 (CN) 201110280175.9

(51) Int. Cl. H04L 5/00

(52) U.S. Cl. CPC H04L 5/0073
USPC 370/329

(57) ABSTRACT

Embodiments of the present invention provide a method for data sending in a multi-user multiple-input multiple-output (MU-MIMO) system. The method includes: sending data to the primary user and the secondary user on the bandwidth on which the clear to send (CTS) sent by the primary user is received and a bandwidth on which the CTS sent by the secondary user is received. The bandwidth on which the request to send (RTS) is sent to the secondary user in this solution may be dynamically adjusted according to an available bandwidth of the primary user, so that sending of unnecessary RTSs on some secondary channels is avoided and send power of an AP and send power of a user are saved.

### CROSS-REFERENCE TO RELATED APPLICATIONS

This application is a continuation of International Application No. PCT/CN2012/074641, filed on Apr. 25, 2012, which claims priority to Chinese Patent Application No. 201110111350.1, filed on Apr. 29, 2011, and Chinese Patent Application No. 201110280175.9, filed on Sep. 20, 2011, all of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

Embodiments of the present invention relate to communications technologies, and in particular, to a method and an apparatus for multi-user data transmission in a wireless local area network.

### BACKGROUND

A mechanism of supporting one kind of transmission opportunity (TXOP) in a wireless local area network means that after one user obtains one channel access opportunity through competition, multiple data frames may be transmitted continuously to one or more users in a certain time. At present, a single-user TXOP (SU TXOP) is supported in a current standard, and a multi-user TXOP (MU TXOP) is added in a new standard. Now, it is required that in the time of transmitting the whole multi-user TXOP, at least one primary user that transmits a primary service type communicates with an access point (AP).

A transmission bandwidth of an AP device or a very high throughput station (VHT STA) has been expanded from originally 20 MegaHertz (MHz) and 40 MHz to 80 MHz and 160 MHz, thereby promoting a communication throughput of a system. However, in consideration of compatibility, a device (AP and VHT STA) needs to have a capability of performing sending and reception on the four bandwidths at the same time. A channel bandwidth that exceeds 20 MHz (40 MHz, 80 MHz, and 160 MHz) is divided into several 20 MHz channels, one of which is a primary 20 M channel, and the remaining are all secondary 20 M channels.

At present, another way to improve the throughput is that the AP transmits data to multiple users (VHT STA) in one TXOP at the same time. After obtaining a TXOP transmission opportunity, and before transmitting data to multiple users, the AP must schedule these users. A method generally adopted is to send a request to send (RTS) to a user to be scheduled, and the user responds with a clear to send (CTS). The RTS and the CTS are control frames that are in common use and their sending bandwidth is 20 MHz. Because of the expansion of a data bandwidth at present, a selected demand supports adoption of sending the RTS and the CTS on each 20 MHz of a wider bandwidth. For example, before the AP sends 80 MHz data, an RTS with completely the same frame format must be sent first on each 20 MHz sub-band of the 80 MHz bandwidth at the same time, and the user responds with a CTS on each corresponding available 20 MHz channel (without interference).

There are mainly two functions for exchange between the RTS and the CTS in multi-user transmission, and a first function is to detect an available bandwidth of each user. Because a secondary channel is under interference, a user may be unable to send a CTS on the secondary channel to respond to an RTS sent by the AP on the same bandwidth. In this way, by exchanging with an RTS/CTS on each sub-channel of each user sequentially, the AP may determine a currently available bandwidth of each user, thereby determining a bandwidth of transmitting multi-user data. A second function is that a frame format of the RTS and the CTS includes one duration field and a receiving address, and each user that has detected a frame of the RTS or the CTS determines, through comparison, whether the receiving address is the same as an address of this user. If the receiving address is not the same as the address of this user, it is defaulted that in this duration time, a channel is busy (occupied by another device) and the user does not access the channel actively, which is referred to as being set with a network allocation vector (NAV). If the receiving address is the same as the address of this user, the user is not set with any NAV, and responds with a corresponding control frame or data frame. This NAV mechanism ensures the communication reliability of a communicating device in this period of time. However, in multi-user transmission at present, the AP needs to perform RTS/CTS exchange with each user on a wider bandwidth (exceeding 20 MHz) sequentially. However, there is no effective exchanging policy, and a sequence and a bandwidth of sending an RTS to each user are not specified, which may cause that a utilization rate of a channel is reduced, thereby reducing an overall throughput of a system.

### SUMMARY

An embodiment of the present invention provides a method for data sending in a multi-user multiple-input multiple-output (MU-MIMO) system. A sequence and a bandwidth of sending an RTS are specified to avoid a scenario that an NAV is erroneously set, thereby improving utilization efficiency of a channel and an overall throughput of a system. The method includes: sending an RTS to a primary user on at least two bandwidths; receiving a CTS that is sent by the primary user on each bandwidth, where the CTS is a response of the primary user to the RTS; sending an RTS to a secondary user on a bandwidth on which the CTS sent by the primary user is received; receiving a CTS sent by the secondary user, where the CTS is a response of the secondary user to the RTS; and sending data to the primary user and the secondary user on the bandwidth on which the CTS sent by the primary user is received and a bandwidth on which the CTS sent by the secondary user is received.

An embodiment of the present invention further provides another simplified method, including: sending an RTS to a primary user on at least two bandwidths; receiving a CTS that is sent by the primary user on each bandwidth, where the CTS is a response of the primary user to the RTS; and sending data to the primary user and all secondary users on a bandwidth on which the CTS sent by the primary user is received.

At the same time, an embodiment of the present invention further provides an apparatus for data sending, including: a sending unit configured to send an RTS to a primary user on at least two bandwidths; and a receiving unit configured to receive a CTS that is sent by the primary user on each bandwidth, where the CTS is a response of the primary user to the RTS, where the sending unit is further configured to send an RTS to a secondary user on a bandwidth on which the CTS sent by the primary user is received; the receiving unit receives a CTS sent by the secondary user, where the CTS is a response of the secondary user to the RTS; and the sending unit is further configured to send data to the primary user and the secondary user on the bandwidth on which the CTS sent by the primary user is received and a bandwidth on which the CTS sent by the secondary user is received.

Further, a wireless local area communication system is further provided, including an access point and user equipments, where the access point first sends an RTS to a primary user in the user equipments before sending multi-user data, then sends an RTS to a secondary user in the user equipments, and receives a CTS that responds to the RTS and is sent by the primary user and a CTS that responds to the RTS and is sent by the secondary user, where a bandwidth on which the RTS is sent to the secondary user does not exceed a bandwidth on which the CTS is sent by the primary user; and the user equipments are configured to receive the RTS sent by the access point, and send the CTS to the access point in response to the RTS.

In the foregoing solutions, before an AP transmits multi-user data, an RTS is sent to only a primary user rather than a secondary user. Therefore, an overhead of a control frame is saved, time of data transmission is increased, and further, a throughput of a system is increased. Furthermore, unnecessary RTS/CTS exchange between the AP and the secondary user is reduced, so that erroneous setting of NAVs of surrounding users is effectively avoided, and these users can access a channel as soon as possible, thereby promoting utilization efficiency of the channel and increasing an overall throughput of the system.

### BRIEF DESCRIPTION OF THE DRAWINGS

FIG. 1 is a flow chart of a method for data sending in a MU-MIMO system according to an embodiment of the present invention;

FIG. 2 is a structural block diagram of an apparatus for data sending in a MU-MIMO system; and

FIG. 3 is a schematic diagram of a wireless local area network system according to an embodiment of the present invention.

### DETAILED DESCRIPTION

In multi-user transmission of a wireless local area network at present, an AP needs to perform RTS/CTS exchange with each user on a wider bandwidth (exceeding 20 MHz) sequentially. However, no specific exchanging policy is specified, namely, no sequence and bandwidth of sending an RTS to each user are specified. If the AP sends an RTS to each user on each 20 MHz sub-band, a sending sequence is random, and because a channel condition of each user is random, a case that a secondary channel of a primary user is under interference and all channels of a secondary user are available may exist.

The AP has at least one primary user (primary STA/destination) when performing multi-user data transmission, and a bandwidth of data sent to each user must be the same, and in this way, the bandwidth of data sent by the AP is the same as an available bandwidth of the primary user. If RTSs are sent to secondary users on a frequency band that exceeds the available bandwidth of the primary user, these RTSs are redundant RTSs, and send power is wasted. In addition, these RTSs sent on the frequency band that exceeds the available bandwidth of the primary user may cause that NAVs of a part of STAs are set unnecessarily, and CTSs to which users respond on these channels may also be set with a NAV of a user around the users unnecessarily, so that these users whose NAVs are set cannot access a channel.

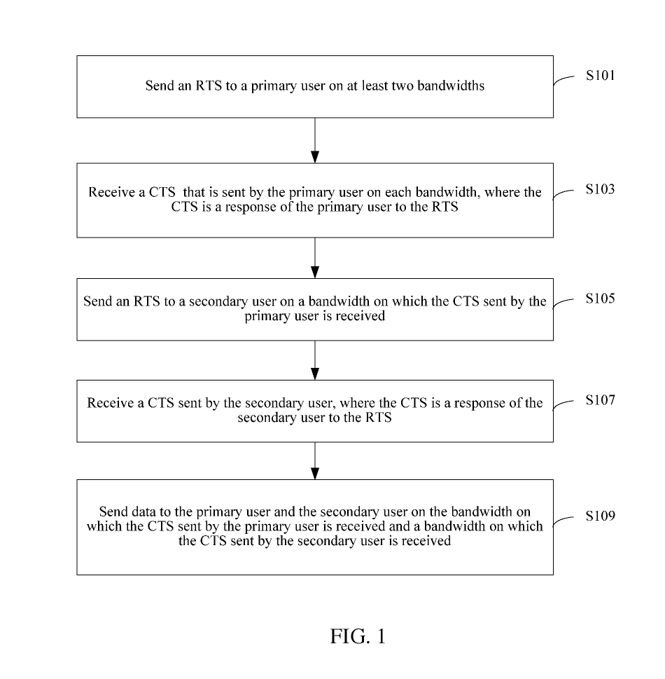

FIG. 1 is a flow chart of a method for data sending in a MU-MIMO system according to an embodiment of the present invention. The procedure is a method for an AP or a VHT STA to send data.

S101: Send an RTS to a primary user on at least two bandwidths.

S103: Receive a CTS that is sent by the primary user on each bandwidth, where the CTS is a response of the primary user to the RTS.

S105: Send an RTS to a secondary user on a bandwidth on which the CTS sent by the primary user is received.

S107: Receive a CTS sent by the secondary user, where the CTS is a response of the secondary user to the RTS.

S109: Send data to the primary user and the secondary user on the bandwidth on which the CTS sent by the primary user is received and a bandwidth on which the CTS sent by the secondary user is received.

It can be seen that, in this embodiment, before an AP sends multi-user data, a sequence of sending an RTS is specified to first send an RTS to a primary user, and then send an RTS to a secondary user. A bandwidth on which the RTS is sent to the secondary user by the AP cannot exceed a bandwidth on which the primary user responds with a CTS (namely, an available bandwidth of the primary user). The bandwidth on which the RTS is sent to the secondary user may be dynamically adjusted according to the available bandwidth of the primary user, so as to avoid sending of unnecessary RTSs on some secondary channels and save send power of the AP and send power of the user. Unnecessary RTS/CTS exchange between the AP and the secondary user is reduced, so that erroneous setting of NAVs of surrounding users is effectively avoided, and these users can access a channel as soon as possible, thereby promoting utilization efficiency of the channel and increasing an overall throughput of a system.

Further, the primary user in the foregoing method refers to all users that transmit a primary service type.

Further, the primary user in the foregoing method may be one in number. If there are multiple primary users in multi-user transmission, first an RTS is sent to all the primary users, and then an RTS is sent to the secondary user. If available bandwidths of the primary users are not consistent (not the same), there are two selection solutions. One is that the bandwidth on which the RTS is sent to the secondary user cannot exceed a maximum value of the available bandwidths of the primary users, and the other is that the bandwidth on which the RTS is sent to the secondary user cannot exceed a minimum value of the available bandwidths of the primary users. Any one of them may be selected according to an actual situation. For example, if the AP selects to send information to only a primary user whose available bandwidth is largest and a secondary user in a TXOP, the bandwidth on which the RTS is sent to the secondary user does not exceed the maximum value of the available bandwidths of the primary users. If the AP selects to send information to all the primary users and the secondary user, the bandwidth on which the RTS is sent to the secondary user does not exceed the minimum value of the available bandwidths of the primary users.

Further, in multi-user transmission, an MU-TXOP is decided by a primary service type. The multi-user transmission first needs to ensure a quality of service (QOS) requirement of the primary service type, and a QOS requirement of a secondary service type is relatively lower. Therefore, during implementation, a simplified RTS sending policy may be adopted according to an actual scenario, for example, a scenario that the density of user stations is low.

Before the AP transmits multi-user data, the RTS is sent to only the primary user rather than the secondary user. Therefore, an overhead of a control frame is saved, time of data transmission is increased, and further, a throughput of a system is increased.

An embodiment of the present invention provides an apparatus for data sending, which may be an AP in a wireless local area network, or may be an application AP in processes of sending and receiving MU-MIMO data. Generally, one AP covers multiple user equipments, and may send data to multiple users. The apparatus in this embodiment is configured to implement the procedure of the foregoing method embodiment, and processing processes in the specific method may all be executed in this apparatus.

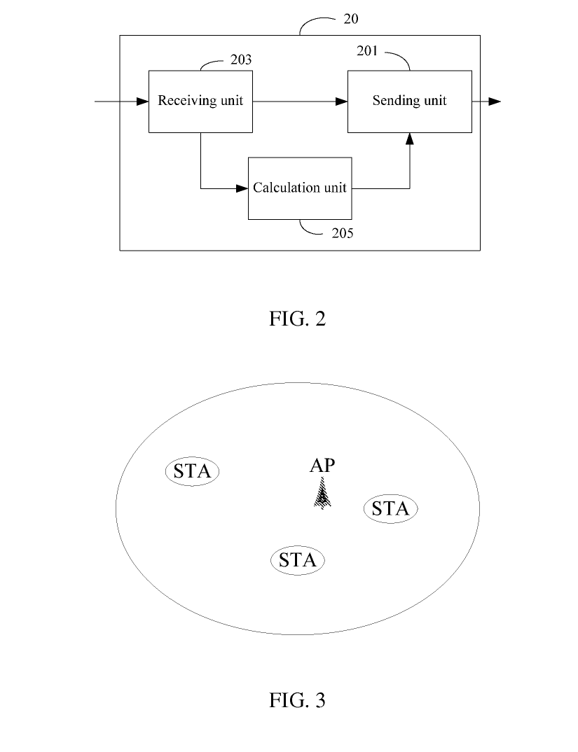

FIG. 2 is a structural block diagram of an apparatus for data sending in a MU-MIMO system.

The apparatus includes a sending unit 201 and a receiving unit 203, where the sending unit 201 is configured to send an RTS to a primary user on at least two bandwidths; the receiving unit 203 is configured to receive a CTS that is sent by the primary user on each bandwidth, where the CTS is a response of the primary user to the RTS; the sending unit 201 is further configured to send an RTS to a secondary user on a bandwidth on which the CTS sent by the primary user is received; the receiving unit 203 receives a CTS sent by the secondary user, where the CTS is a response of the secondary user to the RTS; and the sending unit 201 is further configured to send data to the primary user and the secondary user on the bandwidth on which the CTS sent by the primary user is received and a bandwidth on which the CTS sent by the secondary user is received.

Further, a calculation unit 205 may further be included, which is configured to, if the number of primary users is greater than one, determine a minimum value of a sum of bandwidths on which CTSs are sent by the primary users; and the sending unit 201 is specifically configured to send the RTS to the secondary user on the bandwidth on which the CTS sent by the primary user is received, where a sum of bandwidths on which the RTS is sent to the secondary user does not exceed a bandwidth with the minimum value, and the primary user in the sending data to the primary user and the secondary user on the bandwidth on which the CTS sent by the primary user is received and on the bandwidth on which the CTS sent by the secondary user is received refers to all the primary users. Further, the calculation unit 205 is configured to, if the number of the primary users is greater than one, determine a maximum value of the sum of the bandwidths on which the CTSs are sent by the primary users; and the sending unit 201 is specifically configured to send the RTS to the secondary user on the bandwidth on which the CTS sent by the primary user is received, where the sum of the bandwidths on which the RTS is sent to the secondary user does not exceed a bandwidth with the maximum value, and the primary user in the sending data to the primary user and the secondary user on the bandwidth on which the CTS sent by the primary user is received and on the bandwidth on which the CTS sent by the secondary user is received refers to a primary user that corresponds to the maximum value of the sum of the bandwidths on which the CTSs are sent by the primary users.

A wireless local area network system including the foregoing apparatus and user equipments is provided in the following. The wireless system works according to the foregoing method, and processing processes of a specific method may all be executed in the system. Referring to FIG. 3, the system includes an access point AP and multiple user equipments STA, where the access point AP first sends an RTS to a primary user in the user equipments before sending multi-user data, then sends an RTS to a secondary user in the user equipments, and receives a CTS that responds to the RTS and is sent by the primary user and a CTS that responds to the RTS and is sent by the secondary user, where a bandwidth on which the RTS is sent to the secondary user does not exceed a bandwidth on which the CTS is sent by the primary user; and the user equipments STA are configured to receive the RTS sent by the access point, and send the CTS to the access point in response to the RTS.

The access point AP may be the foregoing apparatus for data sending in a MU-MIMO system, whose specific processing may be to execute each specific processing procedure in the method embodiment.

It can be seen that, with the apparatus and the system in this embodiment, before an AP sends multi-user data, a sequence of sending an RTS is specified to first send an RTS to a primary user, and then send an RTS to a secondary user. A bandwidth on which the RTS is sent to the secondary user by the AP cannot exceed a bandwidth on which the primary user responds with a CTS (namely, an available bandwidth of the primary user). The bandwidth on which the RTS is sent to the secondary user may be dynamically adjusted according to the available bandwidth of the primary user, so as to avoid sending of unnecessary RTSs on some secondary channels and save send power of the AP and send power of the user. Unnecessary RTS/CTS exchange between the AP and the secondary user is reduced, so that erroneous setting of NAVs of surrounding users is effectively avoided, and these users may access a channel as soon as possible, thereby promoting utilization efficiency of the channel and increasing an overall throughput of the system.

Further, an embodiment of the present invention provides another implementation method: in a MU-MIMO transmission system, when an AP adopts an RTS/CTS interaction process to perform transmission opportunity initialization, a first RTS is sent to one of the primary users. When the AP adopts a MU-MIMO data frame to perform transmission opportunity initialization, a first acknowledgment request is sent to one of the primary users.

The primary user mentioned herein refers to a user whose primary access category (AC) data needs to be transmitted, and a secondary user refers to a user whose other access category data except a primary access category needs to be transmitted. The primary access category refers to an access category of obtaining a channel access opportunity through an enhanced distributed channel access function (EDCAF).

In an application, if a first frame is transmitted successfully in one TXOP, a current transmission opportunity is established. In addition, it is further specified that when MU-MIMO transmission is adopted, at least one primary user must be included.

If a target user to which a first RTS is sent is not specified, the following case may occur: when the first RTS is sent to a secondary user, if an AP receives a CTS of the secondary user correctly, a current transmission opportunity is established because a first frame is sent successfully. At this time, if all primary users cannot perform communication because of reasons such as that a channel is under interference, even if the transmission opportunity has been established successfully, data transmission cannot be performed on only the secondary user, which causes waste of transmission time of a system. Therefore, the first RTS is sent to one of the primary users, which may ensure that once the transmission opportunity is established, definitely, a primary user suitable for data transmission exists, so that efficiency of the system may be improved.

A similar case also exists in a scenario that a MU-MIMO data frame is adopted to perform transmission opportunity initialization.

When the AP adopts the MU-MIMO data frame to perform sending, acknowledgment frames of all target users need to be obtained through sequential polling. A first user that feeds back an acknowledgment frame may adopt an explicit acknowledgment request, or may adopt an implicit acknowledgment request, and other users except the first user adopt an explicit acknowledgment request. The implicit request mentioned herein refers to performing of instant feedback setting in a data frame, the explicit request includes but is not limited to a block acknowledgment request frame (BAR), and the acknowledgment frame includes but is not limited to a block acknowledgment frame (BA). When a first user that requests feedback is a secondary user, if a request of the user is received correctly, but subsequently all primary users cannot feed back an acknowledgment frame because of reasons such as interference, at this time, a case that the transmission opportunity is established successfully but no primary user may perform data transmission may also occur. If the AP cannot perform data sending on only the secondary user, waste of system transmission time is caused. Therefore, a first acknowledgment request is sent to one of the primary users, so that after the transmission opportunity is established, a user whose data needs to be transmitted exists, thereby improving efficiency of the system.

Persons of ordinary skill in the art may understand that all or part of the steps in the method embodiment may be implemented by a program instructing relevant hardware. The program may be stored in a computer readable storage medium. When the program runs, the steps in the method embodiment are performed. The storage medium includes any medium that can store program codes, such as a read-only memory (ROM), a random-access memory (RAM), a magnetic disk, or an optical disk.

What is claimed is:

1. A method for data sending in a multi-user multiple-input multiple-output (MU-MIMO) system, comprising:
sending a request to send (RTS) to a primary user on at least two bandwidths;
receiving a clear to send (CTS) that is sent by the primary user on each bandwidth, wherein the CTS is a response of the primary user to the RTS;
sending an RTS to a secondary user on a bandwidth on which the CTS sent by the primary user is received;
receiving a CTS sent by the secondary user, wherein the CTS is a response of the secondary user to the RTS; and
sending data to the primary user and the secondary user on the bandwidth on which the CTS sent by the primary user is received and a bandwidth on which the CTS sent by the secondary user is received.

2. The method according to claim 1, wherein the primary user comprises a user that transmits a primary service type.

3. The method according to claim 1, wherein when a number of primary users is greater than one, sending the RTS to the secondary user on the bandwidth on which the CTS sent by the primary user is received comprises:
determining a maximum value of a sum of bandwidths on which CTSs are sent by the primary users; and
sending the RTS to the secondary user on the bandwidth on which the CTS sent by the primary user is received,
wherein a sum of bandwidths on which the RTS is sent to the secondary user does not exceed a bandwidth with the maximum value, and
wherein the primary user in sending data to the primary user and the secondary user on the bandwidth on which the CTS sent by the primary user is received and on the bandwidth on which the CTS sent by the secondary user is received refers to a primary user that corresponds to the maximum value of the sum of the bandwidths on which the CTSs are sent by the primary users.

4. The method according to claim 1, wherein when a number of primary users is greater than one, sending the RTS to the secondary user on the bandwidth on which the CTS sent by the primary user is received comprises:
determining a minimum value of a sum of bandwidths on which CTSs are sent by the primary users; and
sending the RTS to the secondary user on the bandwidth on which the CTS sent by the primary user is received,
wherein a sum of bandwidths on which the RTS is sent to the secondary user does not exceed a bandwidth with the minimum value, and
wherein the primary user in the sending data to the primary user and the secondary user on the bandwidth on which the CTS sent by the primary user is received and the bandwidth on which the CTS sent by the secondary user is received refers to all the primary users.

5. A method for data sending in a multi-user multiple-input multiple-output (MU-MIMO) system, comprising:
sending a request to send (RTS) to a primary user on at least two bandwidths;
receiving a clear to send (CTS) that is sent by the primary user on each bandwidth, wherein the CTS is a response of the primary user to the RTS; and
sending data to the primary user and all secondary users on a bandwidth on which the CTS sent by the primary user is received.

6. The method according to claim 5, further comprising sending an RTS to a secondary user on a bandwidth on which the CTS sent by the primary user is received.

7. The method according to claim 6, further comprising receiving a CTS sent by the secondary user, wherein the CTS is a response of the secondary user to the RTS.

8. The method according to claim 6, wherein the primary user comprises a user that transmits a primary service type.

9. The method according to claim 6, wherein when a number of primary users is greater than one, sending the RTS to the secondary user on the bandwidth on which the CTS sent by the primary user is received comprises:
determining a maximum value of a sum of bandwidths on which CTSs are sent by the primary users; and
sending the RTS to the secondary user on the bandwidth on which the CTS sent by the primary user is received,
wherein a sum of bandwidths on which the RTS is sent to the secondary user does not exceed a bandwidth with the maximum value, and
wherein the primary user in sending data to the primary user and the secondary user on the bandwidth on which the CTS sent by the primary user is received and on the bandwidth on which the CTS sent by the secondary user is received refers to a primary user that corresponds to the maximum value of the sum of the bandwidths on which the CTSs are sent by the primary users.

10. The method according to claim 6, wherein when a number of primary users is greater than one, sending the RTS to the secondary user on the bandwidth on which the CTS sent by the primary user is received comprises:
determining a minimum value of a sum of bandwidths on which CTSs are sent by the primary users; and
sending the RTS to the secondary user on the bandwidth on which the CTS sent by the primary user is received,
wherein a sum of bandwidths on which the RTS is sent to the secondary user does not exceed a bandwidth with the minimum value, and
wherein the primary user in the sending data to the primary user and the secondary user on the bandwidth on which the CTS sent by the primary user is received and the bandwidth on which the CTS sent by the secondary user is received refers to all the primary users.

11. An apparatus for data sending, comprising:
a sending unit configured to send a request to send (RTS) to a primary user on at least two bandwidths; and
a receiving unit configured to receive a clear to send (CTS) that is sent by the primary user on each bandwidth,
wherein the CTS is a response of the primary user to the RTS,
wherein the sending unit is further configured to send an RTS to a secondary user on a bandwidth on which the CTS sent by the primary user is received,
wherein the receiving unit is further configured to receive a CTS sent by the secondary user,
wherein the CTS is a response of the secondary user to the RTS, and
wherein the sending unit is further configured to send data to the primary user and the secondary user on the bandwidth on which the CTS sent by the primary user is received and a bandwidth on which the CTS sent by the secondary user is received.

12. The apparatus according to claim 11, further comprising:
a calculation unit configured to, when a number of primary users is greater than one, determine a minimum value of a sum of bandwidths on which CTSs are sent by the primary users,
wherein the sending unit is specifically configured to send the RTS to the secondary user on the bandwidth on which the CTS sent by the primary user is received,
wherein a sum of bandwidths on which the RTS is sent to the secondary user does not exceed a bandwidth with the minimum value, and
wherein the primary user in the sending data to the primary user and the secondary user on the bandwidth on which the CTS sent by the primary user is received and the bandwidth on which the CTS sent by the secondary user is received refers to all the primary users.

13. The apparatus according to claim 11, wherein the calculation unit is further configured to, when a number of primary users is greater than one, determine a maximum value of a sum of bandwidths on which CTSs are sent by the primary users, wherein the sending unit is specifically configured to send the RTS to the secondary user on the bandwidth on which the CTS sent by the primary user is received, wherein a sum of bandwidths on which the RTS is sent to the secondary user does not exceed a bandwidth with the maximum value, and wherein the primary user in the sending data to the primary user and the secondary user on the bandwidth on which the CTS sent by the primary user is received and on the bandwidth on which the CTS sent by the secondary user is received refers to a primary user that corresponds to the maximum value of the sum of the bandwidths on which the CTSs are sent by the primary users.

14. A wireless local area network communication system, comprising:
an access point; and
user equipments,
wherein the access point first sends a request to send (RTS) to a primary user in the user equipments before sending multi-user data, then sends an RTS to a secondary user in the user equipments, and receives a clear to send (CTS) that responds to the RTS and is sent by the primary user and a CTS that responds to the RTS and is sent by the secondary user,
wherein a bandwidth on which the RTS is sent to the secondary user does not exceed a bandwidth on which the CTS is sent by the primary user, and
wherein the user equipments are configured to receive the RTS sent by the access point and send the CTS to the access point in response to the RTS.

15. The system according to claim 14, wherein the access point first sends the RTS to the primary user in the user equipments, then sends the RTS to the secondary user in the user equipments, and receives the CTS that responds to the RTS and is sent by the primary user and the CTS that responds to the RTS and is sent by the secondary user, comprises:
sending an RTS to the primary user on at least two bandwidths;
receiving a CTS that is sent by the primary user on each bandwidth, wherein the CTS is a response of the primary user to the RTS;
sending an RTS to the secondary user on a bandwidth on which the CTS sent by the primary user is received;
receiving a CTS sent by the secondary user, wherein the CTS is a response of the secondary user to the RTS; and
sending data to the primary user and the secondary user on the bandwidth on which the CTS sent by the primary user is received and a bandwidth on which the CTS sent by the secondary user is received.

16. The system according to claim 14, wherein when a number of primary users is greater than one, the access point is further configured to:
determine a maximum value of a sum of bandwidths on which CTSs are sent by the primary users; and
send the RTS to the secondary user on the bandwidth on which the CTS sent by the primary user is received,
wherein a sum of bandwidths on which the RTS is sent to the secondary user does not exceed a bandwidth with the maximum value, and
wherein the primary user in the sending data to the primary user and the secondary user on the bandwidth on which the CTS sent by the primary user is received and on the bandwidth on which the CTS sent by the secondary user is received refers to a primary user that corresponds to the maximum value of the sum of the bandwidths on which the CTSs are sent by the primary users.

17. The system according to claim 14, wherein when a number of primary users is greater than one, the access point is further configured to:
determine a minimum value of a sum of bandwidths on which CTSs are sent by the primary users; and
send the RTS to the secondary user on the bandwidth on which the CTS sent by the primary user is received,
wherein a sum of bandwidths on which the RTS is sent to the secondary user does not exceed a bandwidth with the minimum value, and
wherein the primary user in the sending data to the primary user and the secondary user on the bandwidth on which the CTS sent by the primary user is received and the bandwidth on which the CTS sent by the secondary user is received refers to all the primary users.
